(19) United States
(12) Patent Application Publication
(10) Pub. No.: US 2026/0091479 A1
(43) Pub. Date: Apr. 2, 2026

(54) DETACHABLE TABLE EXTENSION

(71) Applicant: Ali Reza Sobhani, Irvine, CA (US)

(72) Inventor: Ali Reza Sobhani, Irvine, CA (US)

(21) Appl. No.: 19/356,937

(22) Filed: Oct. 13, 2025

Related U.S. Application Data
(63) Continuation-in-part of application No. 18/527,124, filed on Dec. 1, 2023.

(51) Int. Cl. B25H 1/00

(52) U.S. Cl. CPC B25H 1/0035

(57) ABSTRACT

A detachable table extension for a table having a first table piece and a support stand coupled to the first table piece. The table extension comprises a second table piece; a first coupler, and a second coupler. The first coupler includes a first end coupled to the second table piece; and a second end releasably coupled with the support structure of the table. The second coupler includes a third end attached to the second table piece and a fourth end rotatably coupled to the first coupler, the first table piece, or the support stand. The second coupler allows the second table piece to be placed on the first table piece or rotated away from the first table piece to then be on a same level as the first table piece.

### CROSS-REFERENCE TO RELATED APPLICATION

This application is a continuation-in-part of and incorporates by reference U.S. Non Provisional application Ser. No. 18/527,124 filed on Dec. 1, 2023.

### BACKGROUND OF THE INVENTION

### 1. Field of the Invention

This invention relates to a modular, detachable table extension system, mounted on locking wheels for portability and stability. More particularly, the invention relates to a device useful in enhancing the convenience and utility of work-surface enhancement systems in everyday life for trade settings and lay settings.

### 2. Description of the Related Art

Tables used by craftsmen and for construction are often used as work surfaces for labor with sharp tools, likely heavy for stability. Oftentimes, portability is compromised and modularity of surface area and orientation are constrained.

Other products offered for detachable table extensions may not meet the desires and needs of professional and at-home consumers who desire table extensions that are secure/stable, convenient to expand and collapse, portable, and versatile.

Currently, there are no useful alternatives that effectively provide and meet the desired characteristics convenience, utility, and versatility. As will be disclosed below, the present disclosure addresses these needs and covers a device and system to enhance the convenience of detachable table extensions to prevent these inconveniences and solve these issues.

### SUMMARY OF THE INVENTION

The present disclosure provides a detachable table extension.

The foregoing and/or other features and utilities of the present disclosure may be achieved by providing a detachable table extension system detachably connected to a work stand, the detachable table extension system including a first table extension, including a first table to increase a surface area of a work surface of a work stand, a plurality of first brackets connected to the first table, each of the plurality of first brackets detachably connected to at least one of a plurality of first legs of the work stand, and a plurality of legs disposed on at least a portion of the first table to support the first table against an external surface in response to contacting the external surface, and a second table extension, including a second table to increase the surface area of the work surface of the work stand, a rod bracket detachably connected to at least one second leg of the work stand, and a support rod connected at a first end to the rod bracket and at a second end to the second table to move the second table from collapsed against the work stand in a first position to at least partially extended away from the work stand in a second position, and move the second table from extended away from the work stand in the second position to at least collapsed against the work stand in the first position.

Each of the plurality of first brackets includes a first bracket surface, and a second bracket surface movably connected to the first bracket surface and configured to move from closed against the first bracket surface in a first position to at least partially opened away from the first bracket surface in a second position, and move from opened away from the first bracket surface in the second position to closed against the first bracket surface in the first position.

Each of the plurality of first brackets further includes a rod-receiving connector disposed at an end of an elongated portion of the first bracket surface.

The first table extension further includes an adjustment rod movably disposed within at least a portion of the rod-receiving connector and connected to the first table and configured to move in a first lateral direction or a second lateral direction within the rod-receiving connector.

The first table moves in a first lateral direction in response to rotating in a first rotational direction, and moves in a second lateral direction in response to rotating in a second rotational direction.

Each of the plurality of legs includes an outer leg movably connected to at least a portion of the first table, and an inner leg movably disposed within at least a portion of the outer leg and configured to move telescopically with respect to the outer leg.

The first table extension further includes a plurality of sliding rods movably connected at a first end to at least a portion of the first table and at a second end to each of the plurality of legs and configured to restrict movement of the plurality of legs along a length of each of the plurality of sliding rods.

The plurality of legs move from disposed against the first table in a first position and slide along the length of each of the plurality of sliding rods to at least partially disposed away from the first table in a second position, and move from disposed away from the first table in the second position and slide along the length of each of the plurality of sliding rods to disposed against the first table in the first position.

The foregoing and/or other features and utilities of the present disclosure may also be achieved by providing a detachable table extension system detachably connected to a work stand, the detachable table extension system including a first table extension, including a first table to increase a surface area of a work surface of a work stand, a plurality of first brackets connected to the first table, each of the plurality of first brackets detachably connected to at least one of a plurality of first legs of the work stand, and a plurality of legs disposed on at least a portion of the first table to support the first table against an external surface in response to contacting the external surface, and a second table extension, including a second table to increase the surface area of the work surface of the work stand that moves in a different direction with respect to movement of the first table, a rod bracket detachably connected to at least a portion of the work stand, and a support rod connected at a first end to the rod bracket and at a second end to the second table to move the second table from collapsed against the work stand in a first position to at least partially extended away from the work stand in a second position, and move the second table from extended away from the work stand in the second position to at least collapsed against the work stand in the first position.

The rod bracket includes a rod-receiving connector movably connected to at least a portion of the work stand and configured to receive the support rod therein, and move in a first rotational direction or a second rotational direction.

The support rod moves in a first lateral direction in response to the second table collapsing against the work stand, and moves in a second lateral direction in response to the second table moving at least partially away from the work stand.

The second table extension further includes a tightening bolt disposed on at least a portion of the rod-receiving connector to prevent movement of the support rod in response to rotating in the first rotational direction and facilitating movement of the support rod in response to rotating in the second rotational direction.

The second table rotates with respect to the support rod in response to moving the second table from the first position to the second position.

The second table extension further includes a base connector configured to detachably connect at a first corner and a second corner of the work surface.

The base connector includes a first clamp disposed on a first end of the base connector to fasten the base connector to the work surface, and a second clamp disposed on a second end of the base connector to fasten the base connector to the work surface.

The second table includes at least one pivot connector movably connected to the first clamp and the second clamp, the at least one pivot connector facilitates movement of the second table with respect to the first clamp and the second clamp.

The foregoing and/or other features and utilities of the present disclosure may also be achieved by providing a method, including increasing a surface area of a work surface of a work stand with a first table, connecting a plurality of first brackets to at least one of a plurality of first legs of the work stand, supporting the first table against an external surface with a plurality of legs in response to contacting the external surface, increasing the surface area of the work surface of the work stand with a second table, connecting a rod bracket to at least a portion of the work stand, and moving, via a support rod, the second table from collapsed against the work stand in a first position to at least partially extended away from the work stand in a second position, and move the second table from extended away from the work stand in the second position to at least collapsed against the work stand in the first position.

The method further including moving the first table in at least one of a first lateral direction and a second lateral direction based on movement of at least one adjustment rod.

Moving the first table in at least one of the first lateral direction and the second lateral direction simultaneously moves the first table in at least one of a first rotational direction and a second rotational direction with respect to the a plurality of first brackets.

The method further including moving the plurality of legs from disposed against the first table in a first position to at least partially disposed away from the first table in a second position, simultaneously moves the plurality of legs along a length of each of a plurality of sliding rods.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 illustrates a perspective view of a detachable table extension coupled with a worktable in accordance with some embodiments.

FIG. 2 illustrates a perspective view of the first table extension in accordance with some embodiments.

FIGS. 3A and 3B illustrate a first coupler of the first table extension in accordance with some embodiments.

FIG. 4 illustrates the first coupler coupled with the work stand in accordance with some embodiments.

FIGS. 5A and 5B illustrates the first table extension and its rotatable and telescoping first stand in accordance with some embodiments.

FIG. 6 illustrates a second table extension rotatably coupled with the work stand in accordance with some embodiments.

FIG. 7 illustrates a second coupler of the second table extension in accordance with some embodiments.

FIG. 8 illustrates a work stand stopper in accordance with some embodiments.

FIG. 9 is a perspective bottom view of a first table extension in accordance with some embodiments.

FIG. 10A is a perspective side view of the first table extension as disposed on the work stand in accordance with some embodiments.

FIG. 10B is a perspective bottom view of the first table extension as disposed on the work stand in accordance with some embodiments.

FIG. 10C is a perspective side view of the first table extension as disposed on the work stand in accordance with some embodiments.

FIG. 10D is a perspective side view of the first table extension as disposed on the work stand in accordance with some embodiments.

FIG. 11 is a perspective bottom view of a second table extension as disposed on the work stand in accordance with some embodiments.

FIG. 12A is a perspective bottom view of the second table extension as disposed on the work stand in accordance with some embodiments.

FIG. 12B is a perspective bottom view of the second table extension as disposed on the work stand in accordance with some embodiments.

FIG. 13 is a perspective top view of an attachment plate as disposed on the first table extension in accordance with some embodiments.

The same elements or parts throughout the figures of the drawings are designated by the same reference characters, while equivalent elements bear a prime designation.

### DETAILED DESCRIPTION

The embodiment and various embodiments can now be better understood by turning to the following detailed description of the embodiments, which are presented as illustrated examples of the embodiment defined in the claims. It is expressly understood that the embodiment as defined by the claims may be broader than the illustrated embodiments described below. Many alterations and modifications may be made by those having ordinary skill in the art without departing from the spirit and scope of the embodiments.

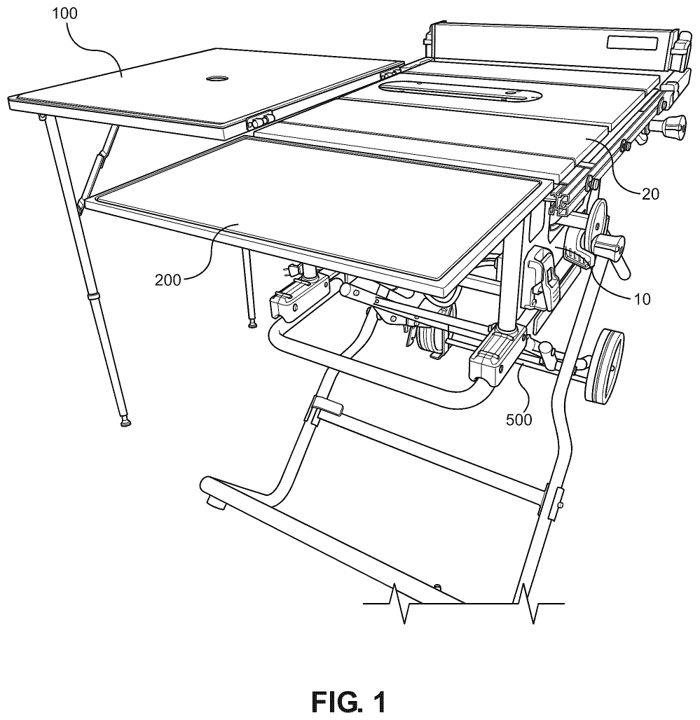

FIG. 1 is a perspective view of the multiple detachable table extensions and a stopper coupled with a work stand. The present invention includes a first table extension 100, a second table extension 200, and a stopper 500 coupled with a work stand 10. The work stand 10 includes a work table 20. As illustrated in FIG. 1, the first table extension 100 and the second table extension 200 are configured to be on the same level as the work table 20, to increase the effective area of the overall area of the system. This increased area allows a user to place a bigger workpiece or additional equipment on the combination table depending on the task at hand. In other words, the table extensions 100, 200 expand the scale of operation a workman can perform on a work stand 10. In the present embodiment, the first and second table extensions 100, 200 are coupled with different part of the work stand 10 and how the table extensions 100, 200 are coupled with the work table 10 will be explained further below.

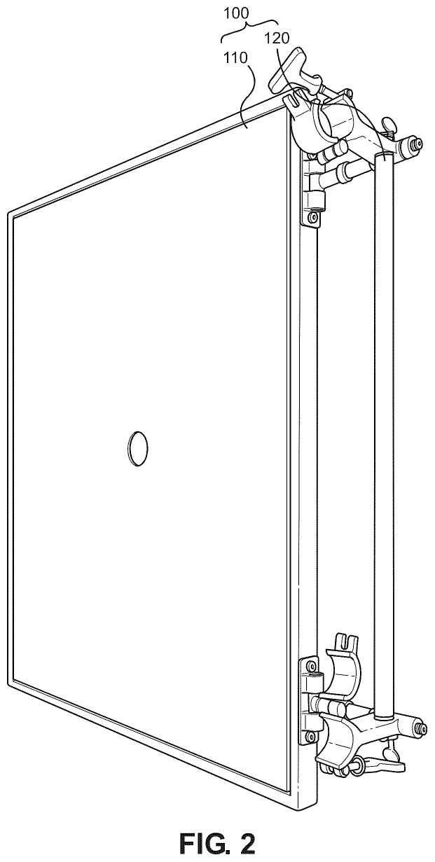

FIG. 2 is a perspective view of the first table extension 100 according to one embodiment of the present invention. The first table extension 100 includes a first table 110 and a first coupler 120 attached on one side of the first table 110.

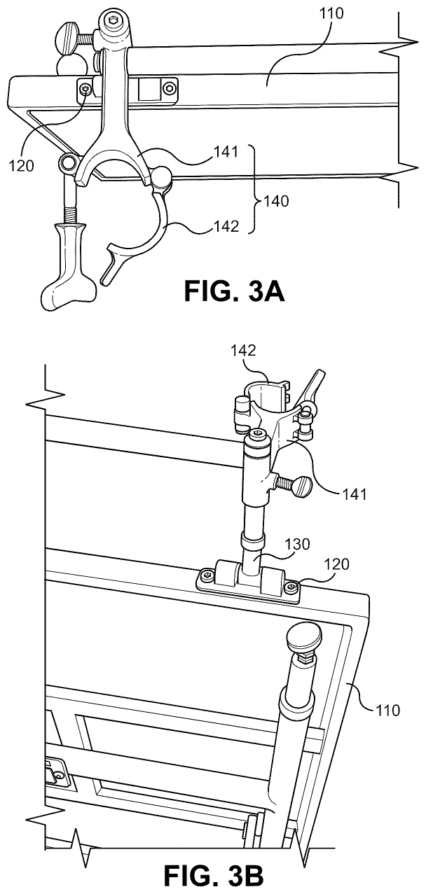

FIGS. 3A and 3B illustrate the first coupler 110 of the first table extension 100 configured to be coupled with a work stand 10. The first table extension 100 includes a first attachment member 120, a first rotator 130, and a first coupling member 140 configured to couple with the work stand 10. In the present embodiment, the first attachment member 120 is configured to be attached on one side of the first table 110 with screws. However, in different embodiments, the first attachment member 120 can be attached to the first table 110 using other conventional methods and components such as clamps, bolt, etc.

The first rotator 130 is rotatably coupled with the first attachment member 120. In the present embodiment, one end of the first rotator 130 is disposed with a pin (not illustrated) to be placed between two half-rings of the first attachment member 120. The above-mentioned configuration maintains the coupling between the first attachment member 120 and the first rotator 130. The half-rings of the first attachment member 120 also allows the pin and its associated first rotator 130 to rotate with respect to the first attachment member 120. The first coupling member 140 includes a first coupling part 141 and a second coupling part 142. As illustrated in FIGS. 3A and 3B, one end of the first coupling part 141 is detachably coupled with the first rotator 130 while the other end is coupled with the second coupling part 142. In the present embodiment, one end of the second coupling part 142 is rotatably coupled with the first coupling part 141 and can be fixed in place with the use of a bolt. However, in different embodiments, the second coupling part 142 can be detachably coupled with the first coupling part 141 and/or fixed in place with other conventional tools such as clamp, screws, etc.

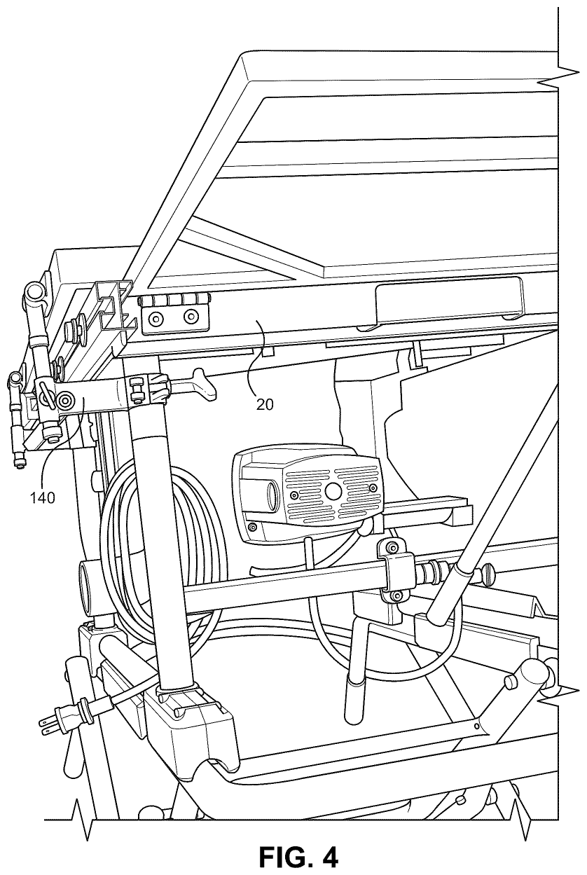

FIG. 4 illustrates the first rotator 140 coupled with the work stand 10. More particularly, the first rotator 140 is coupled with a bar/tube below the work table 20 and perpendicular to the ground. As discussed above, the first and second coupling part 141, 142 are each configured to enclose one half of the bar/tube's circumference. At first, the second coupling part 142 is to rotate away from the first coupling part 141 in order for the bar/tube to be fitted in the space enclosed by the first coupling part 141. The second coupling part 142 is then rotated to enclose the other half of the bar/tube. Finally, a bolt, screw or other conventional tool is used to tighten the first and second coupling 141, 142 together and to make sure that the first rotator 140 is fixed on the bar/tube.

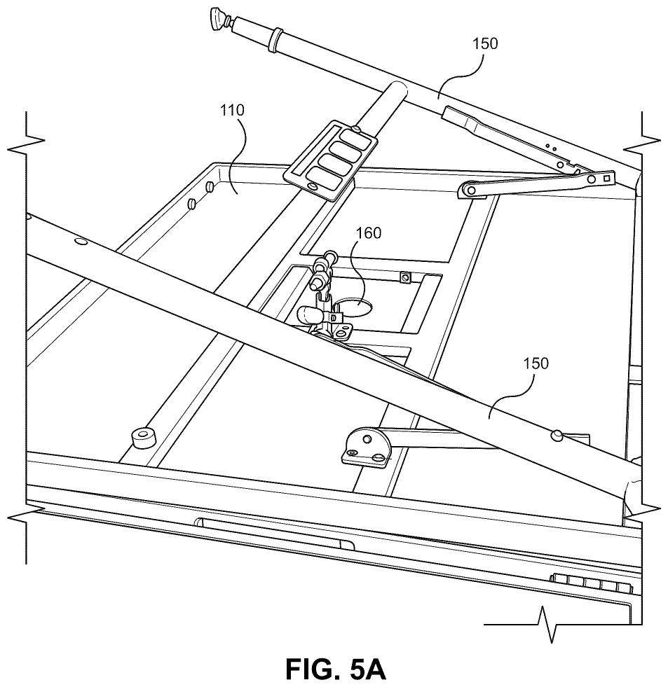

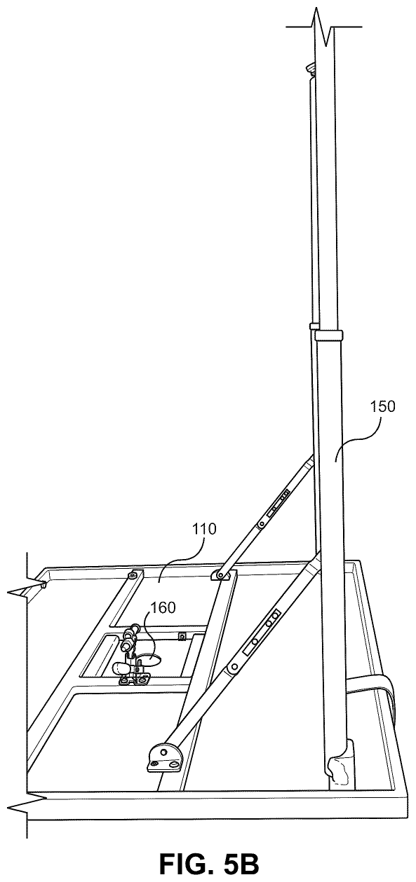

As illustrated in FIGS. 5A-B, the first table extension 100 includes a set of first legs 150 configured to support the first table 110. The length of the first legs 150 is substantially the same as that of the work stand 10 (not illustrated). In the present embodiment, the first legs 150 are telescopic and are rotatably coupled with the first table 110. Accordingly, the length and orientation of the first legs 150 can be adjusted based on the state of the first table extension 100.

In the embodiment discussed above, the first table extension 100 also includes a first opening 160 formed on the first table 110. The first opening 160 allows a user to place a workpiece (such as a wood plank) on the first table 110 and process the workpiece from below the first table 110, through the first opening 160. For instance, a user can drill a wood plank through the first opening 110 from below the first opening 160. In different embodiments, a user can also attach an equipment to the first table 110 in such a way that the part of the equipment configured to interact with a workpiece protrudes the first opening from either side of the first table 110.

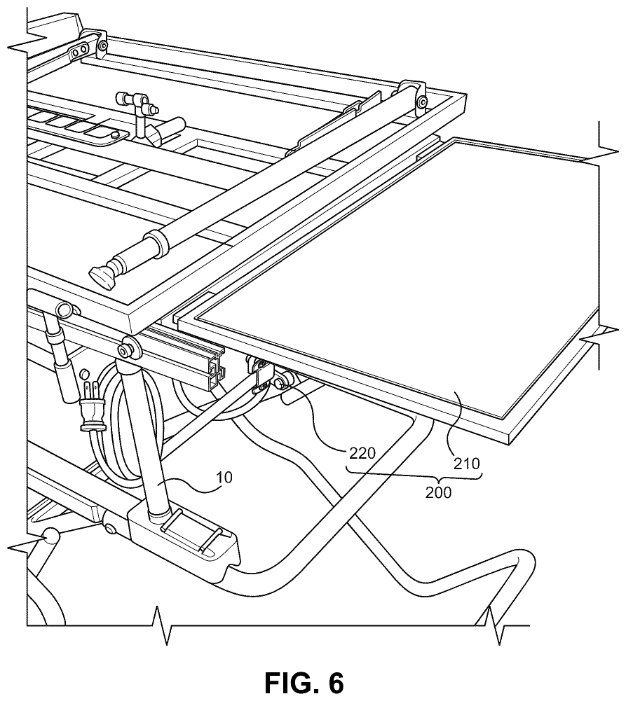

FIG. 6 illustrates the second table extension 200 coupled with work stand 10. As illustrated in FIG. 6, the second table extension 200 is raised to the same level as the work table 20 (illustrated in FIG. 1), to increase the effective area of the overall area of the system. The second table extension 200 includes a second table 210 and a second coupler 220 configured to couple the second table 210 with the work stand 10. In the present embodiment, one end of the second table 210 is rotatably coupled with the work table 20.

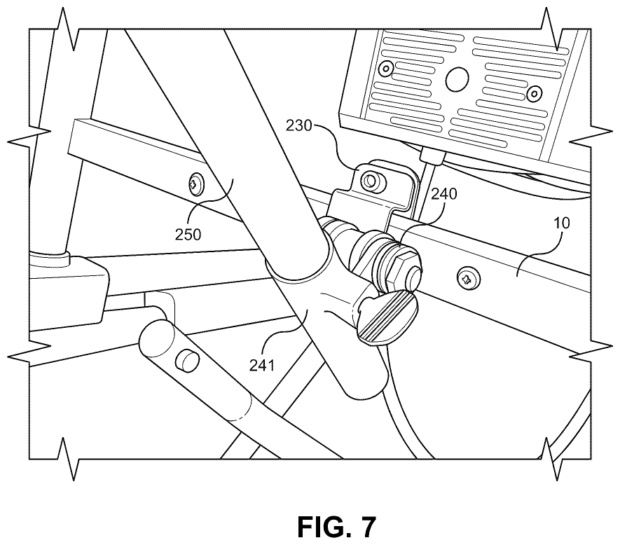

FIG. 7 illustrate the second coupler 220 coupled with the work stand 10. More particularly, the second coupler 220 is coupled with a bar/tube below the work table 20 and substantially horizontal to the ground. The second coupler 220 includes a second attachment member 230, a second rotator 240, and a second leg 250. The second attachment member 230 includes two corresponding pieces configured to surround the horizontal bar/tube of the work stand 10 and are then coupled together using a bolt and a nut or other conventional means of fixing two components together. The second rotator 240 is coupled with the second attachment member 230 and configured to rotate upward and downward with respect to the second attachment member 230.

In the present embodiment, the second leg 250 is a metal tube. On the other hand, the second rotator 240 includes a tubular member 241 configured to accommodate the second leg 250. The second leg 250 has one end rotatably coupled to the second table 210 and a free end telescoping through the tubular member 241. The configuration described above and illustrated in FIG. 7 allows the second table 210 to be rotated and switched between two states, i.e., a first state where the second table 210 is on the same level as the work table 20 (as illustrated in FIG. 6) and a second state where the second table 210 is substantially perpendicular to the ground (not illustrated). Once the second table 210 is raised to the same level as the work table 20, a screw or other suitable means of fixing component in place can be used to tighten the tubular member 241 and the second leg 250 together and maintain the position of the second table 210.

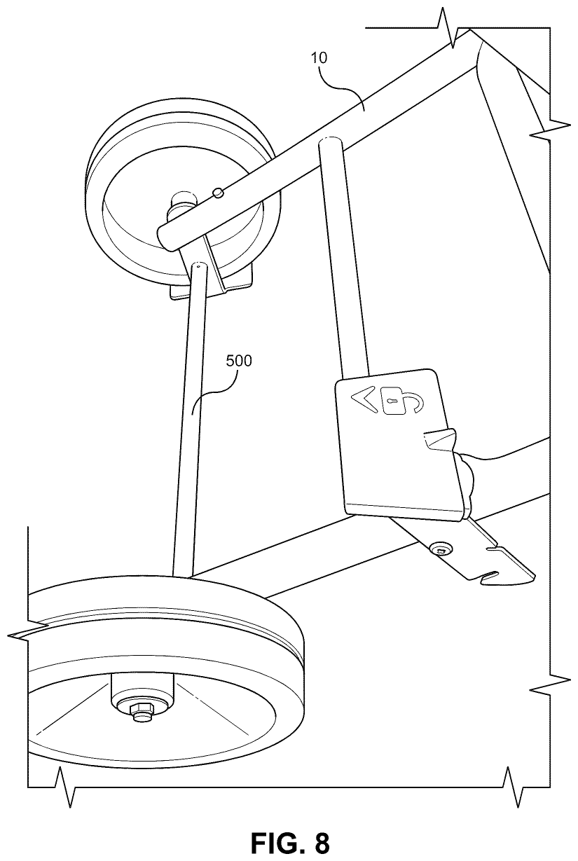

FIG. 8 illustrates a stopper 500 according to one embodiment of the present invention. The stopper 500 is configured to switch between two position, i.e., a first position where the stopper 500 does not hinder the rotation of wheels of the work stand 10 and a second position where the stopper 500 lifts up the wheels to prevents the wheels from rotating (as illustrated in FIG. 8). In the embodiment illustrated in FIG. 8, the stopper 500 is rotatably coupled with the work stand 10. More particularly, the stopper 500 is rotatably coupled with the axle which is also connected to the wheels. A user can selectively rotate the stopper 500 in order to switch between two positions as illustrated in FIG. 8.

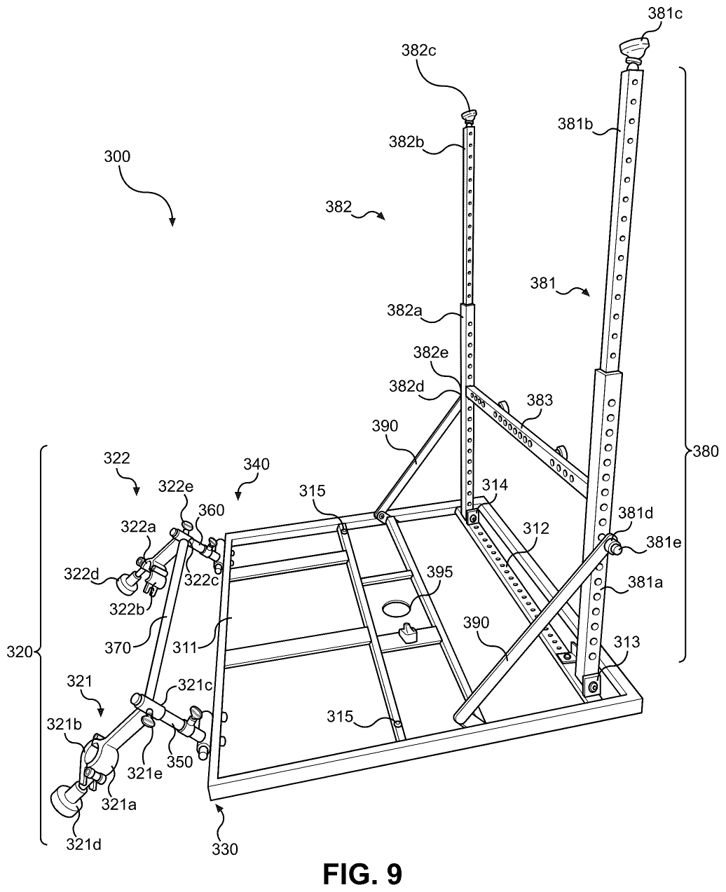

FIG. 9 is a perspective bottom view of a first table extension 310 in accordance with some embodiments. A detachable table extension system 300 is detachably connected to at least a portion of the work stand 10. The detachable table extension system 300 increases a work surface area of the work stand 10. That is, the detachable table extension system 300 expands the work surface area to facilitate work (e.g., construction, repair) performed thereon.

In some embodiments, the detachable table extension system 300 includes a first table extension 310, but is not limited thereto. The first table extension 310 includes a first table 311, a plurality of first brackets 320, a first table connector 330, a second table connector 340, a first adjustment rod 350, a second adjustment rod 360, a connector rod 370, a plurality of legs 380, a plurality of sliding rods 390, and an opening 395, but is not limited thereto. The first table 311 is a planar surface. In the depicted example of FIG. 9, the first table 311 has a rectangular shape. However, in different embodiments, the first table 311 has a circular shape, a triangular shape, a pentagonal shape, a hexagonal shape, a heptagonal shape, an octagonal shape, or any other shape corresponding to the work stand 10 and configured based on the work stand 10. The first table 311 increases the work surface area of the work stand 10 while the first table 311 is connected to the work stand 10.

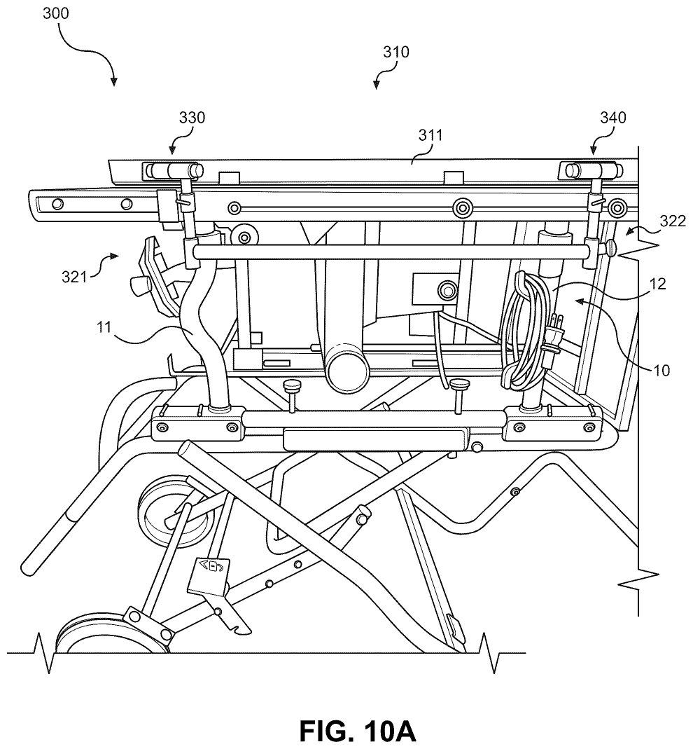

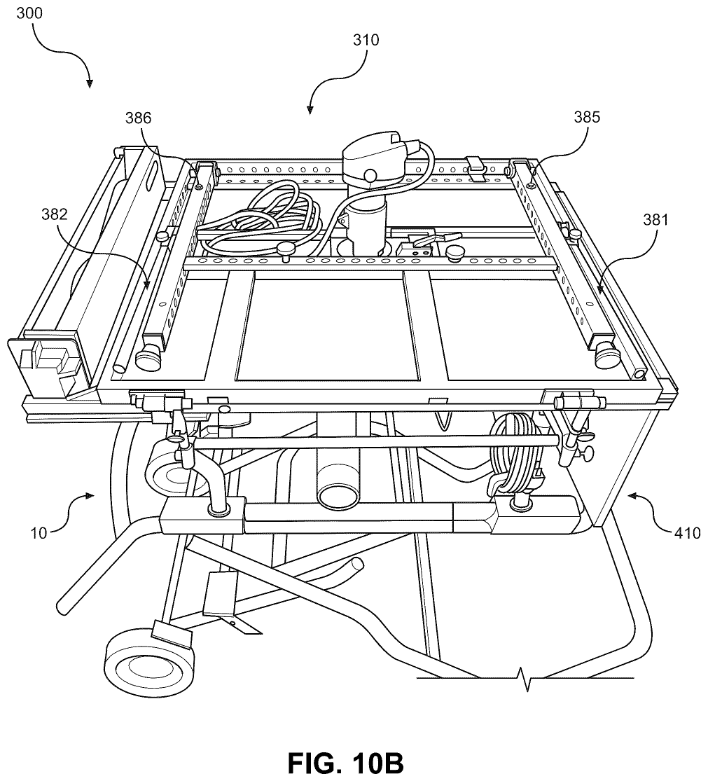

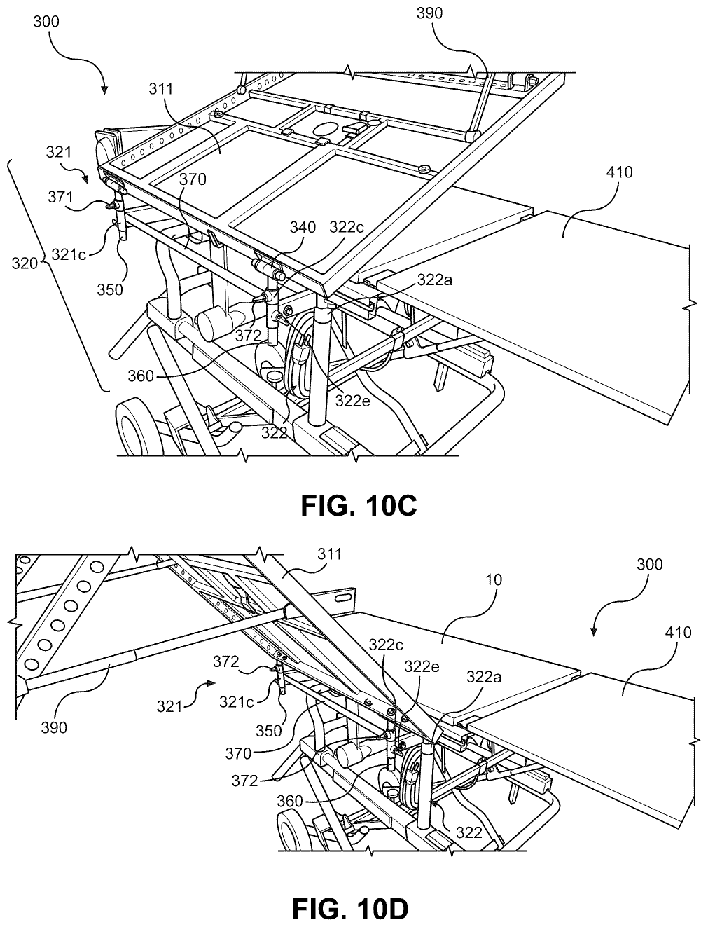

In some embodiments, the plurality of first brackets 320 includes a first bracket 321 and a second bracket 322, but is not limited thereto. In some embodiments, the first bracket 321 includes a first bracket surface 321a, a second bracket surface 321b, a first rod-receiving connector 321c, and a first rod fastener 321d, but is not limited thereto. The first bracket surface 321a is configured to detachably connect (e.g., contact) to a leg and/or a rod of the work stand 10, such as a first leg 11 and/or a second leg 12 of the work stand 10 depicted in FIG. 10A. Similarly, the second bracket surface 321b is configured to detachably connect (e.g., contact) to the leg and/or the rod of the work stand 10, such as the first leg 11 and/or the second leg 12 of the work stand 10 depicted in FIG. 10A. Moreover, the second bracket surface 321b is movably (i.e., pivotally, rotatably, hingedly) connected to the first bracket surface 321a. That is, the second bracket surface 321b moves from closed against the first bracket surface 321a in a first position to at least partially opened away from the first bracket surface 321a in a second position. Conversely, the second bracket surface 321b moves from opened away from the first bracket surface 321a in the second position to closed against the first bracket surface 321a in the first position. In this manner, the first bracket surface 321a and/or the second bracket surface 321b detachably connect to the first leg 11 and/or the second leg 12 of the work stand 10.

The first rod-receiving connector 321c is disposed on at least a portion of the first bracket surface 321a, such as an elongated portion of the first bracket surface 321a at an end disposed away from the second bracket surface 321b. In some embodiments, the first rod fastener 321d includes a screw, a bolt, a nut, a washer, and the like, but is not limited thereto. The first rod fastener 321d is movably (i.e., rotatably) disposed on at least a portion of the second bracket surface 321b. The first rod fastener 321d prevents (i.e., locks) movement of the second bracket surface 321b with respect to the first bracket surface 321a in response to moving (i.e., rotating) the first rod fastener 321d in a first rotational direction (i.e., clockwise) and facilitates (i.e., unlocks) movement of the second bracket surface 321b with respect to the first bracket surface 321a in response to moving the first rod fastener 321d in a second rotational direction (i.e., counterclockwise).

In some embodiments, the second bracket 322 includes a first bracket surface 322a, a second bracket surface 322b, a second rod-receiving connector 322c, and a second rod fastener 322d, but is not limited thereto. The first bracket surface 322a is configured to detachably connect (e.g., contact) to the leg and/or the rod of the work stand 10, such as the first leg 11 and/or the second leg 12 of the work stand 10 depicted in FIG. 10A. Similarly, the second bracket surface 322b is configured to detachably connect (e.g., contact) to the leg and/or the rod of the work stand 10, such as the first leg 11 and/or the second leg 12 of the work stand 10 depicted in FIG. 10A. Moreover, the second bracket surface 322b is movably (i.e., pivotally, rotatably, hingedly) connected to the first bracket surface 322a. That is, the second bracket surface 322b moves from closed against the first bracket surface 322a in a first position to at least partially opened away from the first bracket surface 322a in a second position. Conversely, the second bracket surface 322b moves from opened away from the first bracket surface 322a in the second position to closed against the first bracket surface 322a in the first position. In this manner, the first bracket surface 322a and/or the second bracket surface 322b detachably connect to the first leg 11 and/or the second leg 12 of the work stand 10.

The second rod-receiving connector 322c is disposed on at least a portion of the first bracket surface 322a, such as an elongated portion of the first bracket surface 322a at an end disposed away from the second bracket surface 322b. In some embodiments, the second rod fastener 322d includes a screw, a bolt, a nut, a washer, and the like, but is not limited thereto. The first rod fastener 322d is movably (i.e., rotatably) disposed on at least a portion of the second bracket surface 322b. The first rod fastener 322d prevents (i.e., locks) movement of the second bracket surface 322b with respect to the first bracket surface 322a in response to moving (i.e., rotating) the first rod fastener 322d in a first rotational direction (i.e., clockwise) and facilitates (i.e., unlocks) movement of the second bracket surface 322b with respect to the first bracket surface 322a in response to moving the second rod fastener 322d in a second rotational direction (i.e., counterclockwise).

The first table connector 330 is detachably connected to at least a portion of a first portion of the first table 311. The first table connector 330 is receives a fastener (e.g., a screw, a bolt, a nut, a washer, and the like) therein. In other words, the first table connector 330 includes a fastener receiving hole and/or tube to connect the fastener.

The second table connector 340 is detachably connected to at least a portion of a second portion of the first table 311. The second table connector 340 is receives a fastener (e.g., a screw, a bolt, a nut, a washer, and the like) therein. In other words, the second table connector 340 includes a fastener receiving hole and/or tube to connect the fastener.

In the depicted example of FIG. 9, the first adjustment rod 350 is movably (i.e., slidably) disposed within at least a portion of the first rod-receiving connector 321c and connected to the first table connector 330. Specifically, the first adjustment rod 350 moves (i.e., slides) in a first lateral direction or a second lateral direction within the first rod-receiving connector 321c. Similarly, the second adjustment rod 360 is movably (i.e., slidably) disposed within at least a portion of the second rod-receiving connector 322c and connected to the second table connector 340. Specifically, the second adjustment rod 360 moves (i.e., slides) in the first lateral direction or the second lateral direction within the first rod-receiving connector 321c. As such, the first table 311 moves (i.e., pivots, rotates) with respect to the first bracket 321 and/or the second bracket 322 based on the first table connector 330 and/or the second table connector 340. Also, the first table 311 slides in the first lateral direction or the second lateral direction within the first rod-receiving connector 321c and/or the second rod-receiving connector 322c while rotating on the first table connector 330 and/or the second table connector 340. In other words, the first table 311 changes position (e.g., height) with respect to an external surface (e.g., ground) based on movement of the first adjustment rod 350 and/or the second adjustment rod 360 during rotation of the first table 311 with respect to the first bracket 321 and/or the second bracket 322. That is, the first table 311 changes height (i.e., moving in the first lateral direction or the second lateral direction) while simultaneously rotating.

The connector rod 370 connects the first bracket 321 to the second bracket 322. Thus, the first bracket 321 and the second bracket 322 move (i.e., pivot, rotate) simultaneously with respect to the first table 311 due to the connection between the first bracket 321 and the second bracket 322 based on the connector rod 370, in the manner described above.

In some embodiments, the plurality of legs 380 include a first movable leg 381, a second movable leg 382, and a connecting rod 383, but is not limited thereto. The plurality of legs 380 are disposed on at least a portion of the first table 311. Also, the plurality of legs 380 are movable with respect to the first table 311. In some embodiments, the first movable leg 381 includes a first outer leg 381a, a first inner leg 381b, a first peg 381c, a first rod connector 381d, and a first rod fastener 381e, but is not limited thereto. The first outer leg 381a is movably (i.e., pivotally, rotatably, hingedly) connected to at least a portion of the first table 311, such as a first support bracket 313 on a support rod 312 of the first table 311. In the depicted example of FIG. 9, the first outer leg 381a includes a plurality of holes thereon. The first inner leg 381b is movably (i.e., slidably) disposed at a first end within at least a portion of the first outer leg 381a. In particular, the first inner leg 381b moves from disposed within an interior of the first outer leg 381a in a first lateral position to at least partially extracted from the interior of the first outer leg 381a in a second lateral position. Conversely, the first inner leg 381b moves from extracted from the interior of the first outer leg 381a in the second lateral position to disposed within the interior of the first outer leg 381a in the first lateral position. Stated differently, the first inner leg 381b moves telescopically with respect to the first outer leg 381a. As such, the first inner leg 381b is adjustable to increase a length of the first movable leg 381, such as, for example, adjusting a height of the first movable leg 381, such that the first table 311 is at least partially level with the work surface of the work stand 10.

The first peg 381c is disposed at a second end of the first inner leg 381b. The first peg 381c contacts an external (e.g., ground) surface and/or object to prevent damage to the first outer leg 381a and/or the first inner leg 381b. The first rod connector 381d is movably (i.e., pivotally, rotatably) disposed on at least a portion of the first outer leg 381a. The first rod connector 381d receives a rod therein. The first rod fastener 381e is movably (i.e., pivotally, rotatably) disposed on at least a portion of the first rod connector 381d. The first rod fastener 381e prevents (i.e., locks) movement of the rod within the first rod connector 381d in response to moving (i.e., rotating) the first rod fastener 381e in a first rotational direction (i.e., clockwise) and facilitates (i.e., unlocks) movement of rod within the first rod connector 381d within the first rod connector 381e in response to moving the first rod fastener 381e in a second rotational direction (i.e., counterclockwise).

In some embodiments, the second movable leg 382 includes a second outer leg 382a, a second inner leg 382b, a second peg 382c, a second rod connector 382d, and a second rod fastener 382e, but is not limited thereto. The second outer leg 382a is movably (i.e., pivotally, rotatably, hingedly) connected to at least a portion of the first table 311, such as a second support bracket 314 on the support rod 312 of the first table 311. In the depicted example of FIG. 9, the second outer leg 382a includes a plurality of holes thereon. The second inner leg 382b is movably (i.e., slidably) disposed at a first end within at least a portion of the second outer leg 382a. In particular, the second inner leg 382b moves from disposed within an interior of the second outer leg 382a in a first lateral position to at least partially extracted from the interior of the second outer leg 382a in a second lateral position. Conversely, the second inner leg 382b moves from extracted from the interior of the second outer leg 382a in the second lateral position to disposed within the interior of the second outer leg 382a in the first lateral position. Stated differently, the second inner leg 382b moves telescopically with respect to the second outer leg 382a. As such, the second inner leg 382b is adjustable to increase a length of the second movable leg 382, such as, for example, adjusting a height of the second movable leg 382, such that the first table 311 is at least partially level with the work surface of the work stand 10.

The second peg 382c is disposed at a second end of the second inner leg 382b. The second peg 382c contacts an external (e.g., ground) surface and/or object to prevent damage to the second outer leg 382a and/or the second inner leg 382b. The second rod connector 382d is movably (i.e., pivotally, rotatably) disposed on at least a portion of the second outer leg 382a. The first rod connector 381d receives a rod therein. The second rod fastener 382e is movably (i.e., pivotally, rotatably) disposed on at least a portion of the first rod connector 381d. The second rod fastener 382e prevents (i.e., locks) movement of the rod within the second rod connector 382d in response to moving (i.e., rotating) the second rod fastener 382e in a first rotational direction (i.e., clockwise) and facilitates (i.e., unlocks) movement of rod within the second rod connector 382d within the second rod connector 382e in response to moving the second rod fastener 382e in a second rotational direction (i.e., counterclockwise).

The connecting rod 383 connects the first movable leg 381 to the second movable leg 382, such that the first movable leg 381 and the second movable leg 382 move simultaneously. Furthermore, the first table 311 includes a plurality of magnets 315 disposed thereon to detachably connect to the plurality of legs 380 while the plurality of legs 380 are disposed against the first table 311. In other words, the plurality of magnets 315 resist movement of the plurality of legs 380 away from the first table 311 in absence of an external application of force (e.g., pushing, pulling) by a user. Each of the plurality of sliding rods 390 are movably (i.e., pivotally, rotatably) connected at a first end to at least a portion of the first table 311 and at a second end within the first rod connector 381d and the second rod connector 382d. The plurality of sliding rods 390 restrict movement of the plurality of legs 380 during movement (i.e., rotation) of the plurality of legs 380 on the first support bracket 313 and the second support bracket 314 at least partially along a length of each of the plurality of sliding rods 390. That is, the plurality of legs 380 move from disposed against the first table 311 (e.g., see FIG. 10B) in a first position and simultaneously slide along the length of each of the plurality of sliding rods 390 to at least partially disposed (e.g., perpendicularly disposed) away from the first table 311 in a second position. Conversely, the plurality of legs 380 move from disposed away from the first table 311 in the second position and simultaneously slide along the length of each of the plurality of sliding rods 390 to at disposed against the first table 311 in the first position. In other words, rotation of the plurality of legs 380 simultaneously slides the plurality of legs along the length of each of the plurality of sliding rods 390. It is important to note that the plurality of sliding rods 390 simultaneously change position (i.e., pivot, rotate) from disposed against the first table 311 in the first position to angularly disposed away from the first table 311 in the second position, such as, for example, the position of the plurality of sliding rods 390 in FIGS. 9 and 10B.

The opening 395 allows a user to place a workpiece (such as a wood plank) on the first table 110 and process the workpiece from below the first table 110, through the opening 395. For example, a user can drill a wood plank through the opening 395 from below the opening 395. In different embodiments, an equipment or a work device connected to the first table 311 in such a way that the part of the equipment configured to interact with a workpiece protrudes through the opening 395 from a first side and/or a second side of the first table 311.

FIG. 10A is a perspective side view of the first table extension 310 as disposed on the work stand 10 in accordance with some embodiments.

FIG. 10B is a perspective bottom view of the first table extension 310 as disposed on the work stand 10 in accordance with some embodiments.

FIG. 10C is a perspective side view of the first table extension 310 as disposed on the work stand 10 in accordance with some embodiments.

FIG. 10D is a perspective side view of the first table extension 310 as disposed on the work stand 10 in accordance with some embodiments. FIGS. 10A through 10D illustrate the first table extension 310 as disposed on the work stand 10. More specifically, FIGS. 10A and 10B depict the first table extension 310 disposed against the work surface of the work stand 10 in a first position. Additionally, the first bracket 321 is illustrated as connected to the first leg 11 of the work stand 10 and the second bracket 322 is connected to the second leg 12 of the work stand 10. Referring to FIG. 10B, in some embodiments, the first inner leg 381b includes a first knob 385 and the second inner leg 382b includes a second knob 386. In the depicted example of FIG. 10B, the first knob 385 protrudes from at least one of the plurality of holes on the first outer leg 381a and the second knob 386 protrudes from at least one of the plurality of holes on the second outer leg 382a. The first knob 385 and the second knob 386 prevent movement of the first inner leg 381b and the second inner leg 382b, respectively, while the first knob 385 and/or the second knob 386 protrude from at least one of the plurality of holes. However, the first inner leg 381b and the second inner leg 382b move telescopically within the first outer leg 381a and the second outer leg 382a in response to depressing the first knob 385 and/or the second knob 386 until the first knob 385 and/or the second knob 386 protrude (e.g., pop out from) at least one of the plurality of holes.

Referring to FIGS. 10C and 10D, the first table 311 moves (i.e., pivots, rotates) with respect to the first bracket 321 and/or the second bracket 322 based on the first table connector 330 and/or the second table connector 340. Also, the first table 311 slides in the first lateral direction or the second lateral direction within the first rod-receiving connector 321c and/or the second rod-receiving connector 322c while rotating on the first table connector 330 and/or the second table connector 340. Additionally, the connector rod 370 includes a first end fastener 371 (e.g., a screw, a bolt, a nut, a washer) and a second end fastener 372 (e.g., a screw, a bolt, a nut, a washer), but is not limited thereto.

The first end fastener 371 is movably (i.e., rotatably) disposed at a first end of the connector rod 370. The first end fastener 371 prevents (i.e., locks) movement of the first adjustment rod 350 with respect to the first rod-receiving connector 321c in response to moving (i.e., rotating) the first end fastener 371 in a first rotational direction (i.e., clockwise) and facilitates (i.e., unlocks) movement of the first adjustment rod 350 with respect to the first rod-receiving connector 321c in response to moving the first end fastener 371 in a second rotational direction (i.e., counterclockwise). Similarly, the second end fastener 372 is movably (i.e., rotatably) disposed at a second end of the connector rod 370 opposite to the first end. The second end fastener 372 prevents (i.e., locks) movement of the second adjustment rod 360 with respect to the second rod-receiving connector 322c in response to moving (i.e., rotating) the second end fastener 372 in a first rotational direction (i.e., clockwise) and facilitates (i.e., unlocks) movement of the second adjustment rod 360 with respect to the second rod-receiving connector 322c in response to moving the second end fastener 372 in a second rotational direction (i.e., counterclockwise).

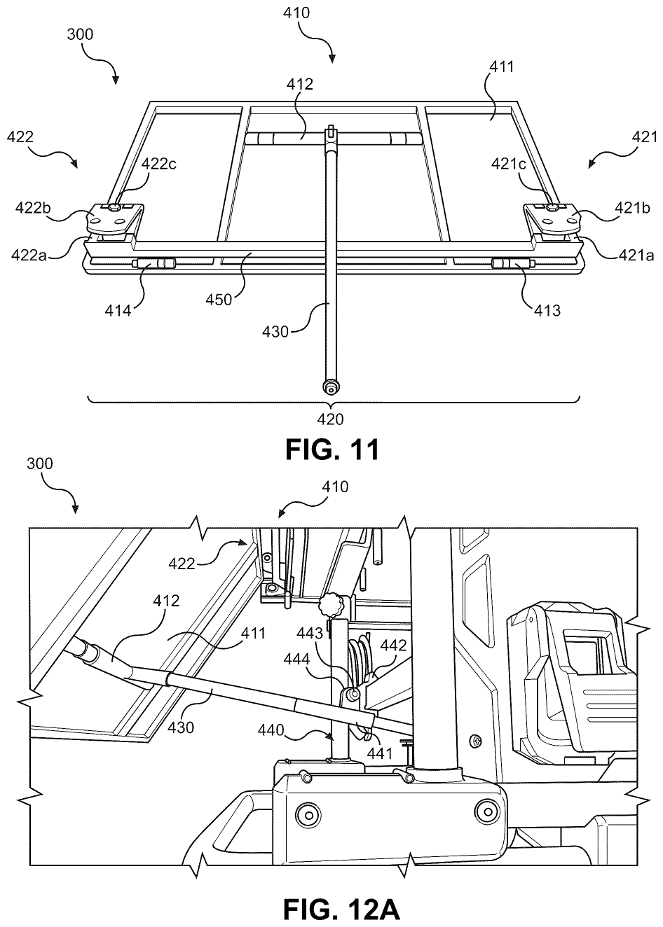

FIG. 11 is a perspective bottom view of a second table extension 410 in accordance with some embodiments.

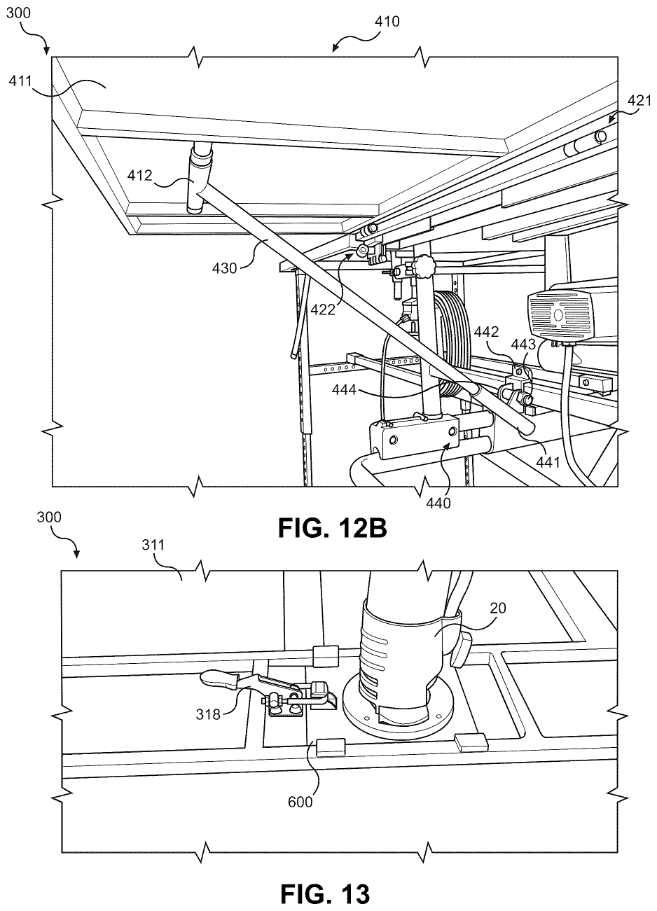

FIG. 12A is a perspective bottom view of the second table extension 410 as disposed on the work stand 10 in accordance with some embodiments.

FIG. 12B is a perspective bottom view of the second table extension 410 as disposed on the work stand 10 in accordance with some embodiments. Referring to FIGS. 11 through 12B, the second table extension 410 includes a second table 411, a base connector 420, a support rod 430, a rod bracket 440, and a pivot rod 450, but is not limited thereto. The second table 411 is a planar surface. In the depicted example of FIG. 11, the second table 411 has a rectangular shape. However, in different embodiments, the second table 411 has a circular shape, a triangular shape, a pentagonal shape, a hexagonal shape, a heptagonal shape, an octagonal shape, or any other shape corresponding to the work stand 10 and configured based on the work stand 10. The second table 411 increases the work surface area of the work stand 10 while the second table 411 is connected to the work stand 10.

In some embodiments, the base connector 420 includes a first clamp 421 and a second clamp 422, but is not limited thereto. The first clamp 421 includes a first clamp surface 421a, a second clamp surface 421b, and a first clamp fastener 421c, but is not limited thereto. The first clamp surface 421a is configured to detachably connect (e.g., contact) to a first corner of the work surface of the work stand 10 as depicted in FIGS. 12A and 12B. Similarly, the second clamp surface 421b is configured to detachably connect (e.g., contact) to a second corner of the work surface of the work stand 10 as depicted in FIGS. 12A and 12B. Moreover, the second clamp surface 421b is movably (i.e., pivotally, rotatably, hingedly) connected to the first clamp surface 421a. That is, the second clamp surface 421b moves from closed against the first clamp surface 421a in a first position to at least partially opened away from the first clamp surface 421a in a second position. Conversely, the second clamp surface 421b moves from opened away from the first clamp surface 421a in the second position to closed against the first clamp surface 421a in the first position. In this manner, the first clamp surface 421a and/or the second clamp surface 421b detachably connect to the work surface of the work stand 10. Furthermore, the first clamp fastener 421c is movably (i.e., rotatably) disposed on at least a portion of the first clamp surface 421a. The first clamp fastener 421c prevents (i.e., locks) movement of the first clamp surface 421a and/or the second clamp surface 421b with respect to the work surface in response to moving (i.e., rotating) the first clamp fastener 421c in a first rotational direction (i.e., clockwise) and facilitates (i.e., unlocks) movement of the first clamp surface 421a and/or the second clamp surface 421b with respect to the work surface in response to moving the first clamp fastener 421c in a second rotational direction (i.e., counterclockwise).

The second clamp 422 includes a first clamp surface 422a, a second clamp surface 422b, and a second clamp fastener 422c, but is not limited thereto. The first clamp surface 422a is configured to detachably connect (e.g., contact) to the work surface of the work stand 10 as depicted in FIGS. 12A and 12B. Similarly, the second clamp surface 422b is configured to detachably connect (e.g., contact) to the work surface of the work stand 10 as depicted in FIGS. 12A and 12B. Moreover, the second clamp surface 422b is movably (i.e., pivotally, rotatably, hingedly) connected to the first clamp surface 422a. That is, the second clamp surface 422b moves from closed against the first clamp surface 422a in a first position to at least partially opened away from the first clamp surface 422a in a second position. Conversely, the second clamp surface 422b moves from opened away from the first clamp surface 422a in the second position to closed against the first clamp surface 422a in the first position. In this manner, the first clamp surface 422a and/or the second clamp surface 422b detachably connect to the work surface of the work stand 10. Furthermore, the second clamp fastener 422c is movably (i.e., rotatably) disposed on at least a portion of the first clamp surface 422a. The second clamp fastener 422c prevents (i.e., locks) movement of the first clamp surface 422a and/or the second clamp surface 422b with respect to the work surface in response to moving (i.e., rotating) the second clamp fastener 422c in a first rotational direction (i.e., clockwise) and facilitates (i.e., unlocks) movement of the first clamp surface 422a and/or the second clamp surface 422b with respect to the work surface in response to moving the second clamp fastener 422c in a second rotational direction (i.e., counterclockwise).

The support rod 430 is movably (i.e., rotatably, pivotally, hingedly) disposed on at least a portion of the second table 411. Specifically, the support rod 430 is disposed on at least a portion of a base rod 412 of the second table 411. Moreover, the support rod 430 moves in response to movement (i.e., rotation) of the base rod 412. Therefore, the support rod 430 moves with respect to the second table 411 based on movement of the base rod 412.

In some embodiments, the rod bracket 440 includes a rod-receiving connector 441, a connector plate 442, a plate fastener 443, and a rod fastener 444, but is not limited thereto. The rod-receiving connector 441 receives the support rod 430 therein. In other words, the support rod 430 is movably (i.e., slidably) disposed within at least a portion of the rod-receiving connector 441. Specifically, the support rod 430 moves (i.e., slides) in the first lateral direction or the second lateral direction within the rod-receiving connector 441. In the depicted example of FIGS. 12A and 12B, the connector plate 442 is disposed against a portion of the work stand 10 and connected (e.g., via a fastener, a screw) to the rod-receiving connector 441. During movement of the second table 411 from disposed against the work stand 10 to at least partially extended away from the work stand 10, the support rod 430 moves away from the work stand 10 in the first lateral direction or the second lateral direction and the rod-receiving connector 441 moves (i.e., rotates) in the first rotational direction or the second rotational direction. Conversely, moving the second table 411 from extended away from the work stand 10 to disposed against the work stand 10, the support rod 430 moves toward the work stand 10 in the second lateral direction or the first lateral direction and the rod-receiving connector 441 moves (i.e., rotates) in the second rotational direction or the first rotational direction.

In some embodiments, the plate fastener 443 includes a screw, a bolt, a washer, a nut, and the like. The plate fastener 443 connects the rod-receiving connector 441 to the connector plate 442. Additionally, the plate fastener 443 facilitates movement (i.e., rotation) of the rod-receiving connector 441 with respect to the connector plate 442.

The rod fastener 444 prevents (i.e., locks) movement of the support rod 430 through the rod-receiving connector 441 in response to moving (i.e., rotating) the rod fastener 444 in a first rotational direction (i.e., clockwise) and facilitates (i.e., unlocks) movement of the support rod 430 through the rod-receiving connector 441 in response to moving the rod fastener 444 in a second rotational direction (i.e., counterclockwise).

The pivot rod 450 is movably (i.e., pivotally, rotatably, hingedly) connected to at least a portion of the second table 411, such as at a first socket 413 and a second socket 414 of the second table 411. In particular, the pivot rod 450 moves (i.e., pivots, rotates) in the first rotational direction or the second direction within the first socket 413 and the second socket 414. Also, the pivot rod 450 connects the first clamp 421 to the second clamp 422. As such, the first clamp 421 and/or the second clamp 422 moves (i.e., pivot, rotate) in response to movement of the pivot rod 450. Accordingly, the second table 411 in response to movement of the pivot rod 450, such as during movement of the support rod 430 through the rod-receiving connector 441.

FIG. 13 is a perspective top view of an attachment plate 600 as disposed on the first table extension 310 in accordance with some embodiments. The attachment plate 600 is a planar surface that facilitates connection of a work equipment 20 to the first table 311. In particular, the attachment plate 600 includes a hole (not shown) that facilitates use of the work equipment 20 through the opening 395 on the first table. Also, the attachment plate 600 connects the work equipment 20 to the first table 311. The attachment plate 600 is connected to the first table 311 via a bar lock 318 to detachably connect to a lock connector on the attachment plate 600.

In the foregoing description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The foregoing detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

1. A detachable table extension system detachably connected to a work stand, the detachable table extension system comprising:
a first table extension, comprising:
a first table to increase a surface area of a work surface of a work stand,
a plurality of first brackets connected to the first table, each of the plurality of first brackets detachably connected to at least one of a plurality of first legs of the work stand, and
a plurality of legs disposed on at least a portion of the first table to support the first table against an external surface in response to contacting the external surface; and
a second table extension, comprising:
a second table to increase the surface area of the work surface of the work stand,
a rod bracket detachably connected to at least one second leg of the work stand, and
a support rod connected at a first end to the rod bracket and at a second end to the second table to move the second table from collapsed against the work stand in a first position to at least partially extended away from the work stand in a second position, and move the second table from extended away from the work stand in the second position to at least collapsed against the work stand in the first position.

2. The detachable table extension system of claim 1, wherein each of the plurality of first brackets comprises:
a first bracket surface; and
a second bracket surface movably connected to the first bracket surface and configured to move from closed against the first bracket surface in a first position to at least partially opened away from the first bracket surface in a second position, and move from opened away from the first bracket surface in the second position to closed against the first bracket surface in the first position.

3. The detachable table extension system of claim 2, wherein each of the plurality of first brackets further comprises:
a rod-receiving connector disposed at an end of an elongated portion of the first bracket surface.

4. The detachable table extension system of claim 3, wherein the first table extension further comprises:
an adjustment rod movably disposed within at least a portion of the rod-receiving connector and connected to the first table and configured to move in a first lateral direction or a second lateral direction within the rod-receiving connector.

5. The detachable table extension system of claim 1, wherein the first table moves in a first lateral direction in response to rotating in a first rotational direction, and moves in a second lateral direction in response to rotating in a second rotational direction.

6. The detachable table extension system of claim 1, wherein each of the plurality of legs comprises:
an outer leg movably connected to at least a portion of the first table;
an inner leg movably disposed within at least a portion of the outer leg and configured to move telescopically with respect to the outer leg.

7. The detachable table extension system of claim 1, wherein the first table extension further comprises:
a plurality of sliding rods movably connected at a first end to at least a portion of the first table and at a second end to each of the plurality of legs and configured to restrict movement of the plurality of legs along a length of each of the plurality of sliding rods.

8. The detachable table extension system of claim 7, wherein the plurality of legs move from disposed against the first table in a first position and slide along the length of each of the plurality of sliding rods to at least partially disposed away from the first table in a second position, and move from disposed away from the first table in the second position and slide along the length of each of the plurality of sliding rods to disposed against the first table in the first position.

9. A detachable table extension system detachably connected to a work stand, the detachable table extension system comprising:
a first table extension, comprising:
a first table to increase a surface area of a work surface of a work stand,
a plurality of first brackets connected to the first table, each of the plurality of first brackets detachably connected to at least one of a plurality of first legs of the work stand, and
a plurality of legs disposed on at least a portion of the first table to support the first table against an external surface in response to contacting the external surface; and
a second table extension, comprising:
a second table to increase the surface area of the work surface of the work stand that moves in a different direction with respect to movement of the first table,
a rod bracket detachably connected to at least a portion of the work stand, and
a support rod connected at a first end to the rod bracket and at a second end to the second table to move the second table from collapsed against the work stand in a first position to at least partially extended away from the work stand in a second position, and move the second table from extended away from the work stand in the second position to at least collapsed against the work stand in the first position.

10. The detachable table extension system of claim 9, wherein the rod bracket comprises:
a rod-receiving connector movably connected to at least a portion of the work stand and configured to receive the support rod therein, and move in a first rotational direction or a second rotational direction.

11. The detachable table extension system of claim 10, wherein the support rod moves in a first lateral direction in response to the second table collapsing against the work stand, and moves in a second lateral direction in response to the second table moving at least partially away from the work stand.

12. The detachable table extension system of claim 10, wherein the second table extension further comprises:
a tightening bolt disposed on at least a portion of the rod-receiving connector to prevent movement of the support rod in response to rotating in the first rotational direction and facilitating movement of the support rod in response to rotating in the second rotational direction.

13. The detachable table extension system of claim 9, wherein the second table rotates with respect to the support rod in response to moving the second table from the first position to the second position.

14. The detachable table extension system of claim 9, wherein the second table extension further comprises:
a base connector configured to detachably connect at a first corner and a second corner of the work surface.

15. The detachable table extension system of claim 14, wherein the base connector comprises:
a first clamp disposed on a first end of the base connector to fasten the base connector to the work surface; and
a second clamp disposed on a second end of the base connector to fasten the base connector to the work surface.

16. The detachable table extension system of claim 15, wherein the second table comprises:
at least one pivot connector movably connected to the first clamp and the second clamp, the at least one pivot connector facilitates movement of the second table with respect to the first clamp and the second clamp.

17. A method, comprising:
increasing a surface area of a work surface of a work stand with a first table;
connecting a plurality of first brackets to at least one of a plurality of first legs of the work stand;
supporting the first table against an external surface with a plurality of legs in response to contacting the external surface;
increasing the surface area of the work surface of the work stand with a second table;
connecting a rod bracket to at least a portion of the work stand; and
moving, via a support rod, the second table from collapsed against the work stand in a first position to at least partially extended away from the work stand in a second position, and move the second table from extended away from the work stand in the second position to at least collapsed against the work stand in the first position.

18. The method of claim 17, further comprising moving the first table in at least one of a first lateral direction and a second lateral direction based on movement of at least one adjustment rod.

19. The method of claim 18, wherein moving the first table in at least one of the first lateral direction and the second lateral direction simultaneously moves the first table in at least one of a first rotational direction and a second rotational direction with respect to the a plurality of first brackets.

20. The method of claim 17, further comprising moving the plurality of legs from disposed against the first table in a first position to at least partially disposed away from the first table in a second position, simultaneously moves the plurality of legs along a length of each of a plurality of sliding rods.
